(19) United States
(12) Patent Application Publication
(10) Pub. No.: US 2023/0231848 A1
(43) Pub. Date: Jul. 20, 2023

(54) SYSTEM AND METHOD FOR AUTHENTICATION OF INTERACTIVE VOICE RESPONSE SERVICE

(71) Applicant: SAMSUNG SDS CO., LTD., Seoul (KR)

(72) Inventors: Semyeong On, Seoul (KR); Changwon Park, Seoul (KR); Keumsik IM, Seoul (KR); Minchul Shin, Seoul (KR); Kyuhyeon Lee, Seoul (KR); Hyejoung Park, Seoul (KR); Hyelim Choi, Seoul (KR); Bogyu Kim, Seoul (KR); Myunghee Kim, Seoul (KR)

(21) Appl. No.: 18/095,071

(22) Filed: Jan. 10, 2023

(30) Foreign Application Priority Data
Jan. 14, 2022 (KR) 10-2022-0006205

(51) Int. Cl. H04L 9/40; H04L 65/4061

(52) U.S. Cl. CPC H04L 63/0876; H04L 65/4061

(57) ABSTRACT

An authentication service system according to an embodiment includes a terminal transmitting a voice call to an interactive voice response service server, identifying a recipient number of the voice call, and transmitting the user's authentication information to an authentication server, the interactive voice response service providing an interactive voice response service according to a user request, and an authentication server generating an authentication key for authenticating the user based on the received authentication information and providing the generated authentication key to the interactive voice response service.

### CROSS-REFERENCE TO RELATED APPLICATION(S)

This application claims benefit under 35 USC § 119 of Korean Patent Application No. 10-2022-0006205, filed on Jan. 14, 2022 in the Korean Intellectual Property Office, the disclosure of which is incorporated herein by reference in its entirety.

### BACKGROUND

### 1. Field

The disclosed embodiments relate to a technology for providing an interactive voice response service using a mobile terminal.

### 2. Description of Related Art

As the functions provided by a contact center have diversified, a voice service has also evolved from an automatic response system (ARS), which provided a simple voice service, to an interactive voice response (IVR), which provides a customized service for each customer. In addition, as mobile devices such as smartphones are widely used, the so-called visible ARS service, which is used while viewing a screen with voice guidance with a smartphone, has become popular.

In the case of such an interactive voice response or visible ARS service, separate identity authentication is essential to provide personalized and customized services. However, in the prior art, there is an inconvenience that a separate procedure for authentication may be required, such as when an agent of a contact center directly asks for personal information during a consultation, or a user inputs information through a keypad.

### SUMMARY

Disclosed one or more embodiments are to provide a way for conveniently providing information for authentication of a service user in an interactive voice response service.

According to an embodiment, an authentication service system includes a terminal configured to send a voice call to an interactive voice response service server, identify a recipient number of the voice call, and transmit authentication information to an authentication server, the interactive voice response service server configured to provide an interactive voice response service according to a request of a user and authenticate the user using an authentication key, and the authentication server configured to generate the authentication key based on the received authentication information and to provide the generated authentication key to the interactive voice response service server.

The authentication information may include a phone number of the terminal and user identification information.

The terminal may acquire the user identification information through a preset authentication.

The authentication server may receive an authentication request of the terminal from the interactive voice response service server receiving the voice call, the authentication request including a phone number of the terminal.

The authentication server may extract user identification information from the authentication information matching the phone number included in the authentication request, and generate the authentication key using the extracted user identification information.

The system may further include a push service server for transmitting web page access information including the authentication key to the terminal, wherein the terminal may access a web page associated with the interactive voice response service using the received web page access information.

According to another embodiment, a terminal includes one or more programs and a memory storing one or more programs configured to be executed by the one or more processors, wherein the one or more programs include: a voice call application for sending a voice call to an interactive voice response service server providing an interactive voice response service according to a request of a user; and an identification information providing application for transmitting the authentication information to an authentication server corresponding to the interactive voice response service by identifying a recipient number of the voice call.

The identification information providing application may search the identified recipient number in a preset recipient number list, and transmit the authentication information when the recipient number is included in the recipient number list.

The authentication information may include a phone number of the terminal and user identification information.

The identification information providing application may acquire the user authentication information through a preset authentication.

The terminal may further include a browsing application for accessing a web page associated with the interactive voice response service by using the web page access information received from the authentication server, the web page access information including an authentication key generated based on the authentication information.

According to another embodiment, an authentication service method is provided, the method including: in a terminal, an operation of sending a voice call to an interactive voice response service server providing an interactive voice response service according to a user request; in the terminal, an operation of transmitting authentication information to an authentication server corresponding to the interactive voice response service by identifying a recipient number of the voice call; in the authentication server, an operation of generating an authentication key for authenticating the user based on the received authentication information; and, in the authentication server, an operation of providing the generated authentication key to the interactive voice response service server.

The authentication information may include a phone number of the terminal and user identification information.

The terminal may acquire the user identification information through a preset authentication.

The method may further include, in the authentication server, an operation of receiving an authentication request including the phone number of the terminal from the interactive voice response service server.

The operation of providing the generated authentication key includes an operation of extracting user identification information from the authentication information matching the phone number included in the authentication request, and an operation of generating the authentication key using the extracted user identification information.

The method may further include, in a push server, an operation of transmitting web page access information including the authentication key to the terminal, wherein the terminal may access a web page associated with the interactive voice response service using the received web page access information.

### BRIEF DESCRIPTION OF DRAWINGS

The above and other aspects, features, and advantages of one or more embodiments of the present disclosure will be more clearly understood from the following detailed description, taken in conjunction with the accompanying lead-outs, in which:

FIG. 1 is a block diagram illustrating an authentication service system 100 in an interactive voice response service according to an embodiment;

FIG. 2 is a block diagram illustrating a detailed configuration of a terminal 102 according to an embodiment;

FIG. 3 is a flowchart illustrating a method 300 for providing authentication information in an authentication service system 100 in an interactive voice response service according to an embodiment; and

FIG. 4 is a block diagram illustrating and describing a computing environment including a computing device suitable for use in exemplary embodiments.

### DETAILED DESCRIPTION

Hereinafter, embodiments in the present disclosure will be described with reference to the accompanying drawings. The disclosure may, however, be exemplified in many different forms and should not be construed as being limited to the specific embodiments set forth herein.

In describing the embodiments of the present disclosure, if it is determined that the detailed description of the known technology related to the present disclosure may unnecessarily obscure the gist of the present disclosure, the detailed description thereof will be omitted. In addition, the terms to be described later are terms defined in consideration of functions in the present disclosure, which may vary according to intentions or customs of users and operators. Therefore, the definition should be made based on the content throughout this specification. The terminology used herein describes particular embodiments only, and the present disclosure is not limited thereby. As used herein, the singular forms “a,” “an,”and “the” are intended to include the plural forms as well, unless the context clearly indicates otherwise. It will be further understood that the terms “comprises,” and/or “comprising” when used in this specification, specify the presence of stated features, integers, steps, operations, members, elements, and/or groups thereof, but do not preclude the presence or addition of one or more other features, integers, steps, operations, members, elements, and/or groups thereof.

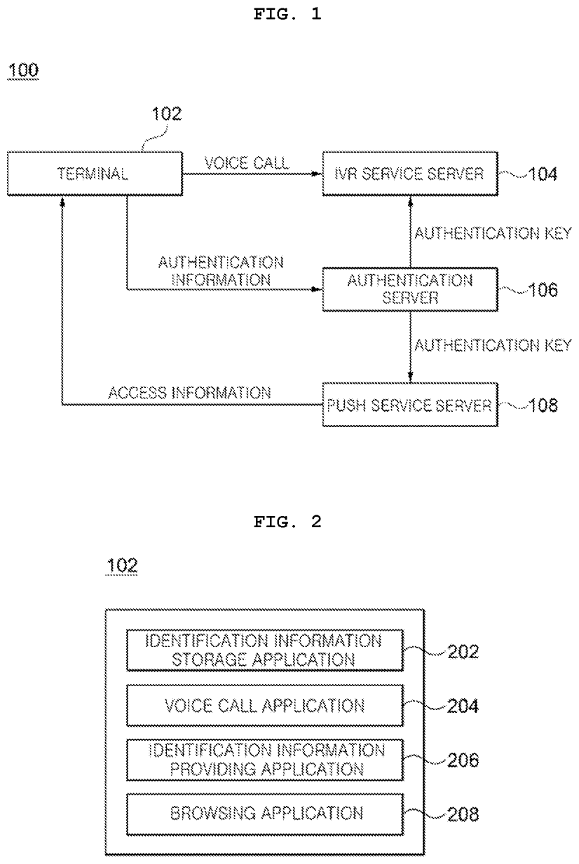

FIG. 1 is a block diagram illustrating an authentication service system 100 in an interactive voice response service according to an embodiment. As illustrated, the authentication service system 100 according to an embodiment includes a terminal 102, an interactive voice response (IVR) service server 104, and an authentication server 106.

The terminal 102 sends a voice call to the IVR service server 104 according to a user request. When a voice call is sent, the terminal 102 identifies a recipient number of the corresponding voice call, detects that the corresponding voice call is a voice call for receiving the IVR service, and transmits user authentication information to the authentication server 106 corresponding to the IVR service server 104. In an embodiment, the terminal 102 may include a mobile device such as a mobile phone, tablet, or smartphone with a voice call function, but not limited thereto.

The IVR service server 104 is a server for receiving a voice call from the terminal 102 and providing an interactive voice response service to the terminal 102. In an embodiment, the IVR service server 104 may be configured to receive an authentication key for authentication of the terminal 102 sending a voice call from the authentication server 106 to be described later, and authenticate the terminal 102 using the received authentication key. That is, the IVR service server 104 may authenticate the terminal 102 using the authentication key provided from the authentication server 106, thereby authenticating the user of the terminal 102 without a process of receiving additional information for separate authentication from the user of the terminal 102.

The authentication server 106 receives authentication information from the terminal 102 and generates an authentication key for authenticating the user, based on the received authentication information.

In an embodiment, the authentication information received from the terminal 102 may include a phone number of the terminal 102 and user identification information of the terminal 102. In this case, the user identification information may include any information that can distinguish the user of the terminal 102 from other users, from personal user information (resident registration number, social security number, vehicle number, and the like) to an encrypted character string, without limitation.

In an embodiment, the terminal 102 may include an identification information storage application which is an application for storing and managing the user authentication information. In this case, the user of the terminal 102 may obtain the identification information by accessing the identification information storage application through a preset authentication, for example, biometric authentication, password authentication, SSO authentication, and the like.

The authentication server 106 may receive authentication request of the terminal 102 from the IVR service server 104 that has received a voice call. In this case, the authentication request may include a caller number of the terminal 102 that has sent the voice call.

The authentication server 106 may identify authentication information matching the caller number included in the authentication request received from the authentication server 106, among the received authentication information, and extract user authentication information included in the identified authentication information. Thereafter, the authentication server 106 may generate an authentication key using the extracted identification information. In an embodiment, the authentication key may be generated using extracted user authentication information and identification information of the IVR service server 104.

In an embodiment, the authentication server 106 may transmit the extracted user identification information to a separate certification authority (CA), and may additionally perform a process of verifying the user authentication information from the certification authority. In this case, the authentication server 106 may generate the authentication key only when the verification of the user authentication information is completed.

The authentication server 106 may provide the generated authentication key to the IVR service server 104, and the IVR service server 104 may authenticate the terminal 102 using the received authentication key.

The authentication service system 100 according to an embodiment may include a push service server 108. The push service server 108 may receive an authentication key from the authentication server 106, and generate web page access information including the authentication key and push the same to the terminal 102. In this case, the web page of the web page access information may be a web page associated with the IVR service.

The terminal 102 may access the web page associated with the IVR service using the received access information and display the accessed web page on a screen. In this case, the web page may be displayed in a logged-in state by the authentication key. That is, according to an embodiment, it is possible to provide a web page in a logged-in state for each user without an input process for a separate login when providing a visible ARS service.

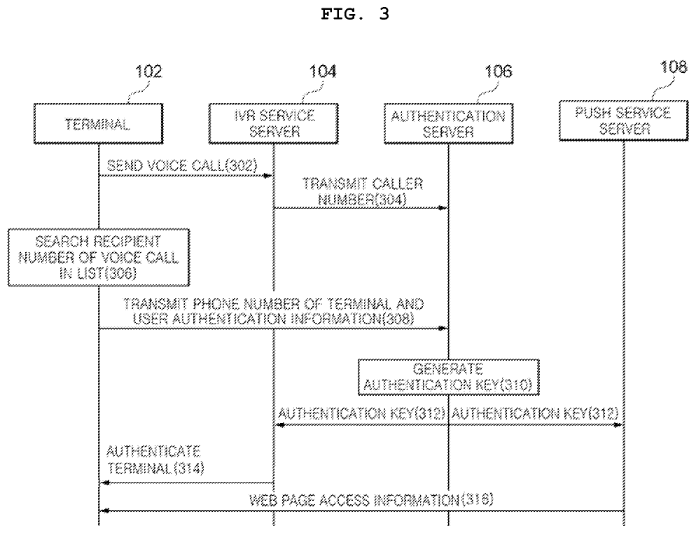

FIG. 2 is a block diagram for illustrating a detailed configuration of a terminal 102 according to an embodiment. The terminal 102 according to an embodiment may include one or more processors, a memory, and one or more programs, wherein the one or more programs may be stored in the memory, and configured to be executed by one or more processors.

As illustrated, the one or more programs included in the terminal 102 according to an embodiment may include an identification information storage application 202, a voice call application 204, an identification information providing application 206, and a browsing application 208.

The identification information storage application 202 is an application for storing and managing identification information of a user of the terminal 102. In an embodiment, the identification information storage application 202 may store the identification information in an internal secure storage region. In this case, the identification information storage application 202 may be configured to provide the identification information only through a separate authentication, for example, the password authentication, SSO authentication, and the like, described above.

The voice call application 204 is an application used for a voice call of the terminal 102. The voice call application 204 may send a voice call to the IVR service server 104 according to a user request and provide the IVR service to the user through the connected voice call.

The identification information providing application 206 identifies a recipient number of the corresponding voice call when a voice call is sent from the voice call application 204, and transmits the user authentication information to the authentication server 106 corresponding to the IVR service having the identified recipient number.

In an embodiment, when a voice call is sent from the voice call application 204, the identification information providing application 206 searches the recipient number of the corresponding voice call from a preset recipient number list. In this case, the recipient number list may be a list including recipient numbers of the IVR service to which authentication information is to be transmitted in order to perform authentication. If the recipient number of the voice call is included in the list, the identification information providing application 206 transmits the authentication information to the authentication server 106 corresponding to the corresponding recipient number. As described above, the authentication information may include a phone number of the terminal 102 and user identification information of the terminal 102. The identification information providing application 206 may acquire the user authentication information from the identification information storage application 202 through a preset authentication.

When web page access information including an authentication key generated based on the authentication information is received from the authentication server 106, the browsing application 208 accesses a web page associated with the IVR service during a voice call using the received access information, and displays the accessed web page on a screen.

FIG. 3 is a flowchart illustrating a method 300 for providing authentication information in the authentication service system 100 in an interactive voice response service according to an embodiment. In the illustrated flowchart, the method or process has been described by dividing the same into a plurality of steps, but at least some of the steps may be performed in a different order, may be performed in combination with other steps, may be omitted, may be performed by dividing the steps into detailed steps, or may be performed by adding one or more steps not illustrated.

In step 302, the terminal 102 sends a voice call to an IVR service server 103 according to a user request.

In step 304, the IVR service server 104 receives the voice call and requests authentication of the terminal 102 to the authentication server 106. In this case, the authentication request may include a caller number of the terminal 102 that has sent the voice call.

In step 306, the terminal 102 identifies a recipient number of the corresponding voice call and searches the above-described recipient number list.

As a result of the search, if the corresponding voice call is a voice call for receiving the IVR service server 104 (that is, if the recipient number exists in the recipient number list), in step 308, the terminal 102 transmits user authentication information to the authentication server 106.

In step 310, the authentication server 106 receives authentication information from the terminal 102, and generates an authentication key for authenticating the user based on the received authentication information. Details related to the authentication information and the authentication key have been described above, and repeated descriptions thereof will be omitted herein.

In step 312, the authentication server 106 transmits the authentication key to the IVR service server 104. According to an embodiment, the authentication server 106 may also transmit the authentication key to the push service server 108.

In step 314, the IVR service server 104 authenticates the terminal 102 using the received authentication key.

In step 316, the authentication server 106 generates web page access information including the authentication key received from the authentication server 106 and pushes the same to the terminal 102. In this case, the web page may be a web page associated with the IVR service. Then, the terminal 102 may access a web page associated with the IVR service 104 using the received access information and display the accessed web page on a screen. In this case, the web page may be displayed in a logged-in state by the authentication key.

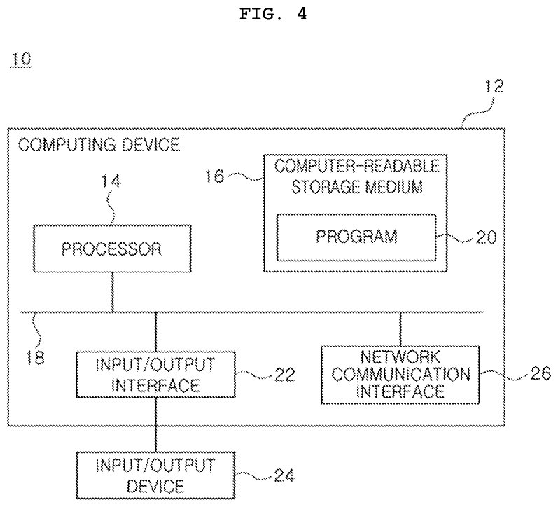

FIG. 4 is a block diagram illustrating and describing a computing environment including a computing device suitable for use in exemplary embodiments. In the illustrated embodiment, respective components may have functions and capabilities different from those described below, and may include additional components other than those not described below.

The illustrated computing environment 10 includes a computing device 12. The computing device 12 may be the terminal 102, the IVR service server 104, the authentication server 106, and the push service server 108, described above.

The computing device 12 includes at least one processor 14, a computer-readable storage medium 16, and a communication bus 18. The processor 14 may cause the computing device 12 to operate in accordance with the exemplary embodiments described above. For example, the processor 14 may execute one or more programs stored in the computer-readable storage medium 16. The one or more programs may include one or more computer-executable instructions and when the computer-executable instructions are executed by the processor 14, the computer-executable instructions may be configured to cause the computing device 12 to perform operations in accordance with the exemplary embodiment.

The computer-readable storage medium 16 is configured to store computer-executable instructions or program code, program data, and/or other suitable form of information. The program 20 stored in the computer-readable storage medium 16 includes a set of instructions executable by the processor 14. In an embodiment, the computer-readable storage medium 16 may include a memory (volatile memory such as a random access memory, non-volatile memory, or a suitable combination thereof), one or more magnetic disk storage devices, optical disk storage devices, flash memory devices, or any other form of storage medium that can be accessed by the computing device 12 and stored for desired information, or a suitable combination thereof.

The communication bus 18 interconnects various other components of computing device 12, including the processor 14 and computer-readable storage medium 16.

The computing device 12 may also include one or more input/output interfaces 22 and one or more network communication interfaces 26 providing an interface for one or more input/output devices 24. The input/output interface 22 and the network communication interface 26 are connected to the communication bus 18. The input/output device 24 may be connected to other components of computing device 12 via input/output interface 22. The exemplary input/output device 24 may include a pointing device such as a mouse, a trackpad, or the like, a keyboard, a touch input device such as a touch pad, a touch screen, or the like, input devices such as voice or sound input devices, various types of sensor devices and/or imaging devices, and/or output devices such as display devices, printers, speakers and/or network cards. The exemplary input/output device 24 may be included in the computing device 12 as a component constituting the computing device 12, and may be connected to the computing device 12 as a separate device distinct from the computing device 12.

As set forth above, according to the disclosed one or more embodiments, it is possible to conveniently provide information for authentication of a service user in an interactive voice response service.

While the example embodiments have been illustrated and described above, it will be apparent to those skilled in the art that modifications and variations could be made without departing from the scope of the present invention as defined by the appended claims.

What is claimed is:

1. An authentication service system, comprising:
a terminal configured to send a voice call to an interactive voice response service server, identify a recipient number of the voice call, and transmit authentication information to an authentication server;
the interactive voice response service server configured to provide an interactive voice response service according to a request of a user and authenticate the user using an authentication key; and
the authentication server configured to generate the authentication key based on the received authentication information and to provide the generated authentication key to the interactive voice response service server.

2. The authentication service system of claim 1, wherein the authentication information comprises a phone number of the terminal and user identification information.

3. The authentication service system of claim 2, wherein the terminal is configured to acquire the user identification information through a preset authentication.

4. The authentication service system of claim 2, wherein the authentication server is configured to receive an authentication request including the phone number of the terminal from the interactive voice response service server.

5. The authentication service system of claim 4, wherein the authentication server is configured to extract the user identification information from the authentication information matching the phone number included in the authentication request, and generate the authentication key by using the extracted user identification information.

6. The authentication service system of claim 1, further comprising:
a push service server configured to transmit web page access information including the authentication key to the terminal,
wherein the terminal is configured to access a web page associated with the interactive voice response service by using the received web page access information.

7. A terminal, comprising:
one or more processors; and
a memory storing one or more programs configured to be executed by the one or more processors,
wherein the one or more programs comprise:
a voice call application for sending a voice call to an interactive voice response service server providing an interactive voice response service according to a request of a user; and
an identification information providing application for transmitting authentication information to an authentication server by identifying a recipient number of the voice call.

8. The terminal of claim 7, wherein the identification information providing application searches the identified recipient number in a preset recipient number list, and transmits the authentication information when the recipient number is included in the recipient number list.

9. The terminal of claim 7, wherein the authentication information comprises a phone number of the terminal and user identification information.

10. The terminal of claim 9, wherein the identification information providing application acquires the user identification information through a preset authentication.

11. The terminal of claim 7, further comprising:
a browsing application for accessing a web page associated with the interactive voice response service by using web page access information received from the authentication server, the web page access information including an authentication key generated based on the authentication information.

12. An authentication service method comprising:
in a terminal, an operation of sending a voice call to an interactive voice response service server providing an interactive voice response service according to a user request;
in the terminal, an operation of transmitting authentication information to an authentication server by identifying a recipient number of the voice call;
in the authentication server, an operation of generating an authentication key for authenticating the user based on the received authentication information; and
in the authentication server, an operation of providing the generated authentication key to the interactive voice response service server.

13. The authentication service method of claim 12, wherein the authentication information comprises a phone number of the terminal and user identification information.

14. The authentication service method of claim 13, wherein the terminal acquires the user identification information through a preset authentication.

15. The authentication service method of claim 13, further comprising:
in the authentication server, an operation of receiving an authentication request including the phone number of the terminal from the interactive voice response service server.

16. The authentication service method of claim 15, wherein the operation of generating the authentication key comprises:
an operation of extracting the user identification information from the authentication information matching the phone number included in the authentication request; and
an operation of generating the authentication key by using the extracted user identification information.

17. The authentication service method of claim 12, further comprising:
in a push server, an operation of transmitting web page access information including the authentication key to the terminal,
wherein the terminal accesses a web page associated with the interactive voice response service using the received web page access information.
